(19) United States
(12) Patent Application Publication
(10) Pub. No.: US 2003/0158324 A1
(43) Pub. Date: Aug. 21, 2003

(54) Latent cross-linking thickeners and rheology modifiers

(76) Inventor: Joseph S. Maxim JR., Chattanooga, TN (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/074,872

(22) Filed: Feb. 12, 2002

(51) Int. Cl. C08L 31/02

(52) U.S. Cl. 524/563

(57) ABSTRACT

The present invention is directed to a latent crosslinking thickener composition having a polymeric thickener which has been modified to contain a functionality capable of forming cross-links at a latter point in time. The latent crosslinking thickener provides thickening properties as well as improvements to a film, coating or viscosity.

### FIELD OF THE INVENTION

This invention relates to latent cross-linking thickeners and rheology modifiers. The latent cross-linking thickeners and rheology modifiers are capable of forming permanent or temporary cross-links when the latent cross-linking mechanism is activated at a point in time after polymerization. The latent crosslinking thickeners and rheology modifiers provide thickening properties to a composition, as well as improvements to a film or coating. Coatings containing the latent cross-linking thickeners and rheology modifiers are useful in a variety of end-use applications including agriculture, adhesive, carpet, cement, construction, coating, detergent, electronic, films, industrial, ink, mastic, mining, non-woven, oil field, packaging, paint, paper, personal care, pesticide, pharmaceutical, textile and waste treatment applications.

### BACKGROUND OF THE INVENTION

Thickeners and rheology modifiers are used to alter the viscosity and/or physical characteristics of a solution to enhance application and storage properties. Many types of thickeners, both oil and water soluble, can be used to increase the viscosity of a solution to enhance it's flow and application properties.

Coatings or binders are known which form cross-links during the process of coalescence or coagulation. However, too much cross-linking in a latex coating or binder can result in a very brittle film, leading to poor impact resistance. Room temperature two part epoxy-cure mechanisms in resin coatings are also known to the art.

EP 0 989 163 describes a cross-linkable composition for use in coatings which is the combination of three polymers: a) a water-soluble acid polymer made water-soluble by addition of a volatile base, b) a carbonyl-functional dispersion, and c) an amine functional polymer, and a cross-linking agent which can react with the carbonyl-functional groups. As a result, two different cross-linking compositions occur after application—a reaction between the acid groups of (a) with the amine functional polymer after the volatile base evaporates, and a reaction between the carbonyl-functional groups of polymer (b) with the cross-linking agent. While the described composition provides ionic attraction, no thickening or rheology modification is provided.

U.S. Pat. No. 4,351,875 describes a textile treatment having a core-shell polymer, where the shell contains a latent crosslinker. The latent cross-linker is not a thickener or a rheology modifier.

The article “Self-crosslinking Acrylic Dispersions Outperform Conventional Solventborne Liquid Inks”; Anton de Krom, et. Al.; American Ink Maker; January 2001 describes a self-crosslinking ink. The ink contains an acrylic binder based on a keto-hydrazide (diacetone acrylamide) and made by a multi-stage emulsion process in the presence of reactive monomers.

U.S. Pat. No. 5,073,591 describes core-shell polymeric thickeners which form cross-linked networks, but fails to describe latent cross-linking.

Current thickeners and rheology modifiers use di-functional, vinyl and allyl cross-linking monomers to increase the polymer molecular weight or to form networks during the polymerization step. Current products are still deficient in that their water solubility and plasticity effects can impart film defects, reduce glass transition temperature (Tg.), gloss and coating longevity.

Another problem with thickeners found in current exterior formulations is that they can migrate to the surface of a film, creating an undesirable chalking appearance.

To over come this deficiency and make the thickener more water resistant, solvent resistant and improve coating strength, the present invention incorporates latent cross-linking functionality into the polymeric thickener composition.

Surprisingly it has been found that thickeners which have been modified with functional groups capable of forming cross-links in the final application resist migration. Additionally, the formation of cross-links due to the modified latent cross-linking thickener provide excellent water resistance and solvent resistance properties to films containing the latent cross-linking thickener or rheology modifier.

### SUMMARY OF THE INVENTION

The present invention is directed to a latent cross-linking thickener composition comprising a polymeric thickener which has been modified to comprise a functionality capable of forming cross-links.

The invention is also directed to a coating formulation containing a latent cross-linking thickener.

### DETAILED DESCRIPTION OF THE INVENTION

The present invention relates to latent cross-linking thickeners, and their use in coating formulations.

Latent cross-linking thickeners, as used herein, refers to compounds and/or systems which both thicken, and are capable of forming cross-links at a point after polymerization. A latent cross-linking functionality is incorporated into a polymeric thickener that is capable of forming permanent or temporary cross-links at some later point in time. The cross-linking mechanisms can be triggered by the removal of water, pH adjustment, a chemical reaction, radiation, or oxidative curing. Cross-links which are formed during polymerization with crosslinking monomers, such as divinylbenzene, diallylphthalate, di or tri acrylates, or methacrylates known to the art of polymerization, are not included within the scope of the present invention.

The cross-linking can occur between separate sites on the same thickener molecule (self cross-linking), between the thickener and a substrate, or with other ingredients and/or polymers in the formulation such as: a blend of polymers in which one polymer contains a functional latent cross-linking groups and the other polymer contains a functional group capable of cross-linking with the first polymer; a functional latent cross-linking polymer can be made by incorporating a blocked functional adduct which can cross-link after activating the functional group by removing the blocking agent; or a cross-linking agent can be added which reacts with a modified polymeric thickener. In addition to permanent cross-linking, temporary cross-linking can occur, such as in the case of a hemi-acetal and hydroxy compound which provides a film with dry strength and solvent resistance, but dissolves in water.

The invention involves a thickener which is modified with a latent cross-linking functionality, that can be triggered at some future point in time.

Thickeners which can be modified according to the invention include both natural and synthetic thickeners. As used herein, a thickener is a hydrophobic or hydrophobic compound used to increase the viscosity of an aqueous or non-aqueous liquid mixture or solution. The thickener may be aqueous, water soluble, water swellable, acid soluble or swellable, alkali soluble or swellable, solvent-based, oil-soluble, or a dry product. Examples of natural thickeners include, but are not limited to alginates; cellulosics and their derivatives such as carboxy methyl cellulose (CMC), hydroxy ethyl cellulose (HEC); guar, and other natural gum products such as arabic gum; kelgin; and starch. Synthetic polymer thickeners are those known in the art, and can be of any architecture including linear, branched, star, and comb. Synthetic polymer thickeners include, but not limited to, polyvinyl alcohol, solution polymers of either cationic, anionic, non-ionic and amphoteric, acid swellable emulsions (H⁺SE), hydrophobically modified acid swellable emulsions (HH⁺SE), alkali swellable emulsions (ASE), hydrophobically modified alkali swellable emulsions (HASE), hydrophobic ethoxylated urethane (HEUR), inverse emulsions, and hydrophobically modified inverse emulsions and suspension polymers.

Latent cross-linking functionality can be incorporated into a copolymer by means of a functional monomer or a reactive group. These functionalities include without limitation, acetal, acid, aldehyde, amino, aziridine, chlorohydrin, epoxy, hemi-acetal, hydroxy, imine, oxazoline, silane, diacetone acrylamide, blocked isocyanate, amino, unsaturated, alcohol and vinyl functional groups, or any other functional group capable of latent cross-linking. The cross-linking functionality can be incorporated into a polymer during the polymerization process, or a polymer can be functionalized following formation of the polymer, as in the case of natural polymers.

When functional monomers are employed they are used at from 0.5 to 30 percent by weight based on the total amount of monomer. The preferred amount of cross-linking functionality in the thickener or rheology modifier is from 2 to 5 percent by weight.

The latent cross-linking mechanism can be triggered by several different conditions including air drying, oven drying, infa-red drying, temperature, microwave, pH adjustment (acid or base), evaporation, oxidation, ultra violet (U.V.). electron beam (E.B.). The latent cross-linking thickeners of the present invention can be activated to form cross-links, or cure, by several different mechanisms just prior to, during, or after final application to a substrate. The specific trigger (activation method) mechanism chosen is based on the latent cross-linking functionality used, product pH, and the final application requirements. Examples include:

| MECHANISM | ACTIVATION | CONDITIONS |
|---|---|---|
| Shiff Base | Water Removal | Air dry, oven dry, IR, microwave |
| | Co-reactant | Diamine, adipic dihydrazide |
| Epoxy | pH adjustment | Evaporation of blocking agent, |
| | (amine-acid) | pH adjustment |
| | | Co-reactant, evaporation |
| Vinyl | Air oxidation | Air/cobalt |
| (unsaturation) | | |
| (unsaturation) | Free radical | Redox, thermal, UV, EB |
| NMA/hydroxyl | Acid, water removal | pH adjustment, oven |
| Acetal | Amine, hydroxide | pH adjustment, drying |
| Hemi-acetal | pH adjustment | water removal |

By a pH cure mechanism is meant that the pH is adjusted with either an acid or base to activate the cross-linking system. Examples of alkaline curing systems include functionalized alkali swellable thickeners in which raising the pH with a base activates the polymer thickening mechanism and also activates a cross linking mechanism. For example, a chorohydrin functionality can form an epoxy ring at higher pH, which can react with a tertiary amine to form a cross-link. Acid curing systems include, for example, acid swellable thickeners containing n-methyol acrylamide and hydroxy propyl acrylate which can form cross-links upon oven drying after an acid is added to activate both the thickener and cross-linking mechanisms.

In an oxidative cure mechanism, the incorporation of a monomer such as castor oil acrylated monomer (unsaturation) into a copolymer may lead to oxidative cross-linking of the unsaturated groups upon air drying. Oxidative curing results in a film having a higher Tg, and increased water and solvent resistance.

Curing by drying involves the removal of water or a volatile blocking component such as acetic acid or ammonia. An examples of this is a latent cross-linking shiff-base mechanism where water is removed as a by product of a reaction, such as between diacetone acrylamide (DAAM) and adipic dihydrazide (ADH).

Water Removal Activation (Shiff Base)

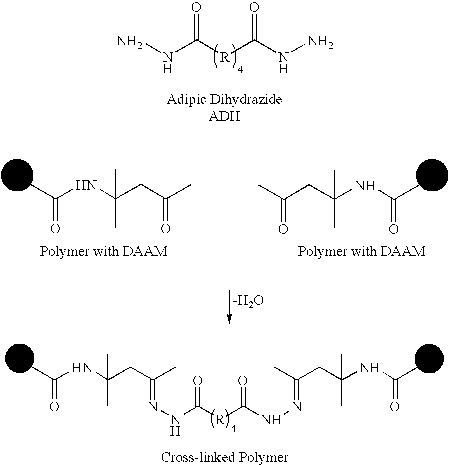

pH Adjustment and Water Removal Activation

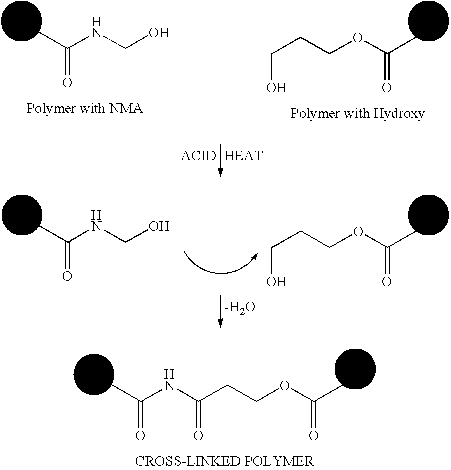

A chemical cure results from the reaction of two chemical species in the polymer film, such as starch plus hydroxy ethyl acrylate, methyl methacrylate and hydroxyl, n-methylol acrylamide and cellulose (wood, paper), epoxy/amine, NMA/hydroxyl, isocyanate/amine (urea), isocyanate/hydroxyl (urethane), diacetone acrylamide/adipic dihydrazide (shiff base), vinyl/free radical (polymerization), vinyl (oxidation air/CO), acid/hydroxyl (condensation), and aldehyde/OH⁻ (aldol condensation).

The latent cross-linking thickeners and rheology modifiers of the present invention may be used in many end-use applications including but not limited to agriculture, adhesive, carpet, cement, construction, coating, detergent, electronic, fabric conditioners, films, industrial, ink, mastic, mining, non-woven, oil field, packaging, paint, paper, personal care, pesticide, pharmaceutical, textile, wallboard and waste treatment applications. The thickener or rheology modifier is generally incorporated into an end-use application at from 0.01 to 30% by weight based on the formulation. This will vary depending on the application.

The latent cross-linking thickeners may be applied to a substrate by any method known in the art, including but not limited to spray, brush, blade, roll, rod, air knife, curtain coater and screen printing.

The incorporation of latent cross-linking functionality to thickeners improves coating properties such as: coating strength, chemical and water resistance, and the reduction or elimination of aqueous thickener leaching which can be detrimental to a adhesive, coating, ink, or paint. Thickener leaching, which is responsible for undesirable chalking, poor water resistance, poor adhesion and inadequate scrub resistance can be reduced by the use of latent cross-linking thickeners.

The following examples are presented to further illustrate and explain the present invention and should not be taken as limiting in any regard.

### EXAMPLE 1

### Cationic Solution Thickener/Shiff Base Cross-linking

A 1 liter, 4 neck round bottom flask is fitted with a nitrogen subsurface sweep, thermocouple, agitator, condenser, heating mantel, and addition funnels. A monomer mixture of 150 g water, 458 g dimethyldiallylammonium chloride(60%DMDAAc), 0.15 g diallyl phthalate (DAP), and 27.5 g of diacetone acrylamide (DAAM) was charged to an addition funnel. An initiator solution of 10 g ammonium persulfate in 75 g of water was charged to a second addition funnel. To the reactor was charged 3 g of 1 percent ethylene tetraacetic acid (EDTA solution). The reactor contents were heated to 75° C., and 5% of each of the monomer and initiator feeds were added to the reactor and held for 15 minutes. The remaining monomer and initiator feeds were then added over three hours. Once the additions were complete, the reactor was held at 75° C. for an additional 3 hours.

Cross-linking was measured by placing 50 grams of the polymer solution made above in a beaker and adding a mixture of 10 grams of water and 1.5 grams of adipic dihydrazide (ADH). Gel time (cross-linking) was measured in minutes as the time it takes from the addition of the aqueous adipic dihydrazide (ADH) solution until an insoluble (cross-linked) gel is formed. The gel time for the above mixture was 3 minutes.

### EXAMPLE 2

### Non-ionic Solution Thickener/Shiff Base Cross-linking

A 1 liter, 4 neck round bottom flask is fitted with a nitrogen subsurface sweep, thermocouple, agitator, condenser, heating mantel, and addition funnels. A monomer mixture of 550 g of acrylamide (50%), and 27.5 g DAAM was charged to an addition funnel. An initiator solution of 75 g ammonium persulfate in 6 g of water was charged to a second addition funnel. To the reactor was charged 150 g of water and 3 g of 1 percent EDTA. The reactor contents were heated to 75° C., and 5% of each of the monomer and initiator feeds were added to the reactor and held for 15 minutes. The remaining monomer and initiator feeds were then added over three hours. Once the additions were complete, the reactor was held at 75° C. for an additional 3 hours.

Cross-linking was measured by placing 100 grams of the polymer solution made above in a beaker and adding a mixture of 10 grams of water and 1.7 grams of adipic dihydrazide (ADH). Gel time (cross-linking) was measured in minutes as the time it takes from the addition of the aqueous adipic dihydrazide (ADH) solution until an insoluble (cross-linked) gel is formed. The gel time for the above mixture was 10 minutes.

### EXAMPLE 3

### HASE Polymer/Shiff Base Cross-linking

A 1.5 liter, 4 neck round bottom flask is fitted with a nitrogen subsurface sweep, thermometer, condenser, heating mantel, and 2 addition funnels. 434 grams of city water and 9 grams of surfactant were added and heated to 85° C. with stirring. A pre-emulsion was mixed in a 1000 ml beaker and added to an addition funnel, consisting of 494 g of city water, 9 g surfactant, 25 g behenyl ethoxylated itaconate (BEI) monomer, 210 g of ethyl acetate, 211 grams of methacrylic acid, and 42 g diacetone acrylamide. 5% of the feed was added to the reactor once it reached 75° C., and after a 15 minute hold a solution of 0.45 g of ammonium sulfate in 31 g of water was added. After 15 minutes a slow add of the remaining 95% of the monomer pre-emulsion and an initiator solution of 0.2 g ammonium persulfate in 58 g of water were each added over 90 minutes. The reaction was then held at 85° C. for another hour and a solution of 0.3 g of ammonium sulfate in 18 g of water added. After another 75 minutes at 85° C., the reactor was cooled to room temperature followed by the addition of 21.5 grams of adipic dihydrazide followed by 15 minutes of mixing.

### EXAMPLE 4

### H⁺SE Thickener/NMA/OH Cross-linking (Self Cross-linking)

An emulsion polymer consisting of dimethyldiethylaminomethacrylate (DMAEMA)/ethyl acrylate (EA)/hydroxy ethyl acrylate (HEMA)/n-methylol acrylamide (NMA) (47:47:4:2 wt %) is adjusted to a pH of 6.0 with an organic acid, making the emulsion polymer water soluble causing thickening of the formulation. During drying of the formulation, cross-links can form between the NMA and hydroxyl groups of the thickener. Depending on the amount of cross-linking, improved strength and solvent and water resistance can be achieved.

### EXAMPLE 5

### HH⁺SE/NMA/OH Cross-linking (Self Cross-linking)

An emulsion polymer of DMAEMA/EA/BEI/HEMA/NMA (44:44:6:4:2 wt %) is treated in the same manner as in Example 4.

### EXAMPLE 6

### H⁺SE/NMA Cross-linking (Alcohol/Diol Cross-linking)

An emulsion polymer of DMAEMA/EA/NMA (49:49:2 wt %) is combined in a formulation with a multifunctional alcohol, such as polyvinyl alcohol, starch, and a hydroxy containing synthetic polymer, diol or polyol. The formulation is then neutralized to below pH 6.0 to solubilize and activate the acid activated thickener. Drying of the lower pH formulation produces cross-links formed between the NMA groups of the thickener and hydroxyl groups of other ingredients. Strength and solvent/water resistance can be improved by optimizing cross-link density.

### EXAMPLE 7

### H⁺SE/Temporary Cross-linking (Self Cross-linking)

An emulsion polymer of DMAEMA/EA/HEMA/Hemi-acetal acrylate (49:49:2 wt %) is synthesized. The hemi-acetal (blocked aldehyde) group is stable and un-reactive under alkaline conditions. When the pH is lowered below 6.0, the thickener will solubilize and gain viscosity. After the polymer dries the aldehyde group under acidic conditions can cross-link with the alcohol functionality.

### EXAMPLE 8

### Acid Curing Temporary Cross-linking

An emulsion polymer of DMAEMA/EA/HEMA/Hemi-acetal acrylate (46:46:6:2 wt %) is synthesized. The hemi-acetal (blocked aldehyde) group is stable and un-reactive under alkaline conditions. When the pH is lowered below 6.0, the thickener will solubilize and gain viscosity. After the polymer dries the aldehyde group under acidic conditions can cross-link with the alcohol functionality.

### EXAMPLE 9

### Acid Curing Temporary Cross-linking

An emulsion polymer of DMAEMA/EA//Hemi-acetal acrylate (48:48:4 wt %) is synthesized. The hemi-acetal (blocked aldehyde) group is stable and un-reactive under alkaline conditions. When the pH is lowered below 6.0, the thickener will solubilize and gain viscosity. The thickener will cross-link with other multifunctional alcohols in the formulation like polyvinyl alcohol, starch and other hydroxy containing synthetic polymers. These temporary cross-links are not hydrolytically stable. Addition of water to the cross-linked polymer, breaks the cross-links, making the polymer completely water soluble. This technology could be used in time release coatings, detergent granulating, kitty liter, encapsulation, or forming detergent pellets.

### EXAMPLE 10

### Acid Curing Temporary Cross-linking

An emulsion polymer of DMAEMA/EA//Hemi-acetal acrylate (45:45:6:4 wt %)is synthesized. The emulsion behaves in a similar manner to that of Example 9.

### EXAMPLE 11

### Alkaline Curing

An emulsion polymer is prepared having the composition glacial methacrylic acid (GMAA)/EA/chlorohydroxypropyl methacrylate (CHPMA)/DMAEMA ⊕·SO4⁻(45:45:5:5 wt %). This alkali swellable emulsion thickens after the pH is adjusted with a base to >7.0. When the pH is increased, the chlorohydrin forms an epoxy ring that can react with the tertiary amine monomer resulting in cross-linking. This reaction occurs at room temperature resulting in an increase in viscosity. When dried, the film becomes insoluble in water and/or solvent due to the degree of cross-linking. The cross-linking can also improve film strength.

### EXAMPLE 12

### Alkaline Curing

An emulsion polymer is prepared having the composition GMAA/EA/CHPMA/DMAEMA ⊕·SO4⁻(40:45:5:5:5 wt %). It can be used in a manner as described in Example 11.

### EXAMPLE 13

### Oxidative Drying Curing

An emulsion polymer is prepared having the composition GMAA/EA/HEMA/CAM (45:45:5:5 wt %). Incorporation of CAM (castor acrylated monomer) into a thickener composition allows efficient ambient cross-linking. When dried, oxidative cross-linking of the unsaturated groups can occur. The dried film becomes insoluble in water and/or solvent due to the degree of cross-linking. This cross-linking can also improve film strength.

### EXAMPLE 14

### Oxidative Drying Curing

An emulsion polymer is prepared having the composition GMAA/EA/BEI/HEMA/CAM (40:45:5:5:5:% wt %). The polymer performs in a manner similar to that of Example 13.

### EXAMPLE 15

### Oxidative Drying Curing (Non-ionic)

An emulsion polymer is prepared having the composition AA/CAM (95:5 wt %). The non-ionic solution polymer thickener can be made which can cross-link upon drying. When dried, oxidative cross-linking of the unsaturated groups can occur. The dried film becomes insoluble in water and/or solvent due to the degree of cross-linking. This cross-linking can also improve film strength.

### EXAMPLE 16

### Oxidative Drying Curing (Anionic)

An emulsion polymer is prepared having the composition acrylamide (ACM)/CAM (95:5 wt %). The anionic solution polymer thickener can be made which can cross-link upon drying. When dried, oxidative cross-linking of the unsaturated groups can occur. The dried film becomes insoluble in water and/or solvent due to the degree of cross-linking. This cross-linking can also improve film strength.

### EXAMPLE 17

### Oxidative Drying Curing (Cationic)

An emulsion polymer is prepared having the composition DMDAAc/CAM (95:5). The cationic solution polymer thickener can be made which can cross-link upon drying. When dried, oxidative cross-linking of the unsaturated groups can occur. The dried film becomes insoluble in water and/or solvent due to the degree of cross-linking. This cross-linking can also improve film strength.

### EXAMPLE 18

### drying/Evaporative Curing

An emulsion polymer is prepared having the composition GMAA/EA/DAAM (45/52/3 wt %). An alkali swellable emulsion thickens after the pH is adjusted with a base to >7.0. Incorporation of the DAAM monomer into the thickener composition allows a room temperature cross-link to form when the material is air dried making a water and chemical resistant coating. Shiff Base formation occurs between the DAAM monomer and adipic dihydrazide (ADH) used as a co-reactant in a “one part” cross-linking system.

The emulsion will also cross-ling upon air drying without neutralization. The spray dried cross-linked emulsion can used dry as a super absorbent for diapers, thickener replacement for Personal Care and for numerous industrial uses.

### EXAMPLE 19

### Drying/Evaporative Curing

A polymer is prepared having the composition GMAA/EA/BEI/DAMM (40/51/6/3 wt %). This polymer performs in a manner similar to that of Example 18.

### EXAMPLE 20

### Drying/Evaporative Curing

A polymer is prepared having the composition DMAEMA/EA/DAAM (48:48:4 wt %) This thickener is an acid swellable emulsion which thickens after the pH is adjusted with an acid to >6.0. Incorporation of the DAAM monomer into the thickener composition allows for a room temperature cross-link to form when the material is air dried, producing a water and chemical resistant coating. Shiff Base formation occurs between the DAAM monomer and adipic dihydrazide (ADH) used as a co-reactant in a “one part” cross-linking system.

The emulsion will also cross-ling upon air drying without neutralization. The spray dried cross-linked emulsion can used dry as an acid timed release compound in Personal Care formulations and numerous other industrial uses.

### EXAMPLE 21

### Drying/Evaporative Curing

A polymer is prepared having the composition DMAEMA/EA/BEI/DAAM (45:45:6:4 wt %). The polymer performs in a manner similar to that of Example 20.

### EXAMPLE 22

### Drying/Evaporative Curing (Epoxy)

A solution polymer is prepared having the composition ACM/CHPMA/DMAEMA ⊕·⁻ OOCH₃ (96:2:2 wt %) whereby the aqueous thickener can cross-link upon drying alone. The acetic acid will evaporate after drying forming an epoxy at pH 8.0 which can react with the unblocked tertiary amine. A clear brittle film will form which will have water and solvent resistance.

### EXAMPLE 23

### Epoxy Curing (Diamines or Diamine Oligomers)

1,4 hydroxy-2-butene butane diol is epoxidized with peracetic acid to form the epoxy adduct drawn below.

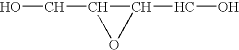

The epoxy diol is used in a HEUR urethane reaction.

### EXAMPLE 24

### Oxidative Cure

1,4 hydroxy-2-butene is reacted into a HEUR (hydrophobic modified urethane resin) for latent cross-linking thickener using an air oxidation CO catalyst system.

### EXAMPLE 25

### U.V. Cure

A polymer is prepared having a composition DMAEMA/EA/GMA (47:47:4 wt %).

The acid swellable emulsion polymer will be made before the GMA (glycidyl methacrylate) is added. This is done to protect the double bond on the GMA molecule so it can react during a U.V. cure.

The post added GMA monomer will react with the tertiary amine on the DMAEMA pre-polymer using TMAC as a catalyst at 60C. A free radical source is added to the emulsion. After the emulsion is solubilized with an acid, the polymer adduct can undergo free radical cross-linking when the film dries and is exposed to U.V. light. The dried film becomes insoluble in water and/or solvent due to the degree of cross-linking. This cross-linking can also improve film strength including solvent and water resistance.

### EXAMPLE 26

### U.V. Cure

In a similar manner as in Example 26, a polymer is prepared having the composition DMAEMA/EA/BEI/GMA (45:45:6:4 wt %). The polymer performs in a manner similar to that in Example 25.

### EXAMPLE 27

### Heat, Redox, or Radiation Cure

An acid swellable emulsion polymer is prepared having the composition GMAA/EA/GMA (47:47:4 wt %). The emulsion polymer is made before the GMA is added. This is done to protect the double bond on the GMA molecule so it can react during a free radical cure. The post added GMA monomer will react with the acid group on the GMAA (glacial methacrylic acid) group using tetramethyl ammonium chloride (TMAC) as catalyst at ˜60 C. A free radical source is added to the emulsion. After the emulsion is solubilized with a base, the free radical source can be activated by heat (thermal), co-reactant (redox), U.V. (ultra violet), EB (electron beam), or microwave and the polymer adduct can undergo free radical cross-linking. The dried film becomes insoluble in water and/or solvent due to the degree of cross-linking. This cross-linking can also improve film strength

### EXAMPLE 28

### Heat, Redox, or Radiation Cure

In a similar manner to Example 28, a polymer is prepared having the composition GMAA/EA/BEI/GMA (45:45:6:4 wt %). The latent cross-linking thickener performs in a manner similar to that in Example 27.

What is claimed is:

1. A latent cross-linking thickener or rheology modifier composition comprising a polymeric thickener which has been modified to comprise at least one functionality capable of forming cross-links.

2. The composition of claim 1 wherein said cross-linking occurs after the thickener is applied to a substrate.

3. The composition of claim 1 wherein said modification comprises at least one functionality selected from the group consisting of acetal, aldehyde, epoxy, hemi-acetal, silane, diacetone acrylamide, aziridine, blocked isocyanate, amino, chlorohydrin, hydroxy, imine, oxazoline, acid, and vinyl functional groups.

4. The composition of claim 1 wherein said polymeric thickener is a natural thickener selected from the group consisting of alginates, cellulosics and their derivatives, guar, arabic gum, kelgin, starch, and mixtures thereof.

5. The composition of claim 1 wherein said polymeric thickener is a synthetic polymer thickener selected from the group consisting of polyvinyl alcohol, cationic solution polymers, anionic solution polymers, non-ionic solution polymers, amphoteric solution polymers, acid swellable emulsions, hydrophgobically modified acid swellable emulsions, alkali swellable emulsions, hydrophobically modified alkali swellable emulsions, hydrophobic ethoxylated urethane, inverse emulsions, hydrophobically modified inverse emulsions, and suspension polymers.

6. The composition of claim 1 wherein the ratio of the thickener to the functional groups is from 0.5-30 weight percent

7. The composition of claim 1 wherein said cross-link formation can be triggered by air drying, oven drying, infa-red drying, microwave, temperature adjustment, pH adjustment, evaporation, oxidation, ultra violet, or electron beam.

8. A coating composition comprising the latent cross-linking thickener of claim 1.

9. The coating composition of claim 8 comprising from 0.01 to 30 weight percent of said cross-linking thickener.

10. A method of thickening a composition and providing improved film properties comprising
a) combining the composition of claim 1 into a formulation;
b) applying said formulation to a substrate; and
c) triggering the cross-linking reaction.
